(19) United States
(12) Patent Application Publication
(10) Pub. No.: US 2026/0253865 A1
(43) Pub. Date: Aug. 27, 2026

(54) MANUFACTURE OF FREE-STANDING ELECTRODE FILM USING DIFFERENTIAL SPEED ROLLER PRESS

(71) Applicant: LICAP TECHNOLOGIES, INC., Sacramento, CA (US)

(72) Inventors: Martin Zea, Sacramento, CA (US); Eric Fodge, Sacramento, CA (US); Erika Shaw, Sacramento, CA (US); Michael Phan, Sacramento, CA (US); Linda Zhong, Sacramento, CA (US); Jerry Her, Sacramento, CA (US); Bibek Tiwari, Sacramento, CA (US)

(21) Appl. No.: 19/174,618

(22) Filed: Apr. 9, 2025

Related U.S. Application Data
(63) Continuation-in-part of application No. 19/061,880, filed on Feb. 24, 2025.

(51) Int. Cl. H01M 4/04; H01M 4/02; H01M 4/62; H01M 10/04

(52) U.S. Cl. CPC H01M 4/0435; H01M 4/623; H01M 10/0404; H01M 10/0468; H01M 2004/028

(57) ABSTRACT

A method of manufacturing a free-standing electrode film for an energy storage device includes providing a powder mixture including at least one electrode active material and at least one fibrillizable binder, with the powder mixture having been subjected to a shear force to fibrillize the at least one fibrillizable binder. The method may further include feeding the powder mixture between a first pair of opposed working rolls having different respective surface speeds to produce a free-standing electrode film. The first pair of opposed working rolls may be controlled so that the different respective surface speeds are at a ratio between 1:1 and 1:10 and a roll gap between the rolls is equal to or larger than 1 μm. A resulting free-standing electrode film may exhibit few, if any, damaged active material particles. A dry electrode manufacturing line may include a film formation press and fewer than four film compression presses.

### CROSS-REFERENCE TO RELATED APPLICATIONS

This application is a continuation-in-part of U.S. patent application Ser. No. 19/061,880, filed Feb. 24, 2025 and entitled “MANUFACTURE OF FREE-STANDING ELECTRODE FILM USING DIFFERENTIAL SPEED ROLLER PRESS,” the entire disclosure of which is incorporated by reference.

### STATEMENT RE: FEDERALLY SPONSORED RESEARCH/DEVELOPMENT

Not Applicable

### BACKGROUND

### 1. Technical Field

The present disclosure relates generally to manufacturing energy storage devices such as Li-ion batteries, solid state batteries, sodium ion batteries, Li-ion capacitors (LIC), and ultracapacitors and, more particularly, to dry processes for the manufacture of electrodes for energy storage devices.

### 2. Related Art

As demand for cost-effective energy storage devices increases, various methods have been proposed for manufacturing electrodes. Among these, there exist so-called “dry” processes by which an electrode may be manufactured while avoiding the expense and drying time associated with the solvents and aqueous solutions that are typically used in slurry coating processes. One of the many advantages of an electrode made by a dry process is the uniform binder distribution in the electrode active layer due to the lack of binder migration associated with the drying process in the slurry coating method. Another advantage of an electrode made by a dry process is that the active material particles are not fully covered by the binder layer, which otherwise acts as an electrically insulating layer causing higher electrical resistance as well as behaving like a physical barrier when ions in the electrolyte are moving through and intercalating into or out of the active material particles during charging and discharging processes. Recently, free-standing film based dry process electrode manufacture has gotten industry attention due to its scalability, sustainability, and high performance. An electrode film may be considered a “free-standing” film when it is a self-supporting electrode active layer that maintains structural integrity without the need for a traditional metallic current collector (e.g., copper or aluminum) or any other substrate or supportive surface during or after its formation. In a free-standing film based dry process, a dry powder mixture, after binder fibrillization, is pressed into a free-standing film using a roller press, after which the resulting free-standing electrode film may pass through one or more additional roller presses until its thickness is reduced as needed for the energy storage device to be produced. The free-standing electrode film may then be laminated to a current collector in order to produce an electrode.

One of the major advantages of producing a dry electrode using free-standing film based dry electrode technology is that the electrode active layer can be modified, and the tolerance can be controlled freely, without any interference caused by or risk of damage to a substrate material. The lamination of the active layer onto the current collector may be the last electrode manufacture step, at a stage when the active layer of the electrode already has been made to meet all specifications and requirements, such as electrode thickness and electrode density (and uniformity thereof), as well as loading and power requirements. There is no need to modify the electrode properties after the active layer is bonded to the current collector, such as by a calender densification step in the case of slurry coating processes, which frequently results in the current collector being damaged.

For a high-speed manufacturing process, the free-standing electrode film that is produced must be of high quality. If a free-standing film has defects, such as cracks or holes, the film will break during the manufacturing process, which will lead to low productivity and low yield. If a free-standing film is brittle, rather than flexible, or if the film does not have enough strength, only a low-speed manufacturing process is possible, which means the process is not scalable or sustainable. Low film quality is normally associated with incomplete binder fibrillization in the powder mixing process. Manufacturing processes that do not include binder activation (either chemically, thermally or mechanically), or processes that use improper input energy or incorrect fibrillization conditions during mixing (from the design point of view of the mixer or the mixing process), as well as processes that begin with inferior formulation development, will likely lead to low film quality.

Different active materials behave differently when subjected to free-standing film based dry electrode manufacturing processes. The requirements of the roller presses and/or the number of presses in an electrode manufacturing line (also called a mill line) are largely different for different active materials. In the cases of battery cathode electrodes, the active materials are normally harder to press to the required thickness than carbon based active materials, such as activated carbon or graphite-based materials. Further, higher power application energy storage devices normally require thinner active layers on the electrodes to meet higher C rate requirements, for example, an electrode for electric vehicle batteries whose active layer thickness may be 65 μm or less to reach a C rate of 3 C or 4 C. In such cases, an increased number of presses for producing free-standing films in the dry electrode manufacturing line may be required. Unfortunately, as the number of presses needed to achieve the target thickness of the free-standing film increases, the associated capital expenditure of the mill line increases and so does the complexity of the mill line. And further, the likelihood of equipment failure and human error increases and the manufacturing yield and throughput decrease due to the increased complexity. Another major disadvantage associated with the higher number of presses in manufacturing battery electrodes for electric vehicles is that the active material particles may be deformed or cracked by the many presses, which shortens the battery cycle life.

### BRIEF SUMMARY

The present disclosure contemplates various systems, apparatuses, and methods, as well as related products, for overcoming the above drawbacks accompanying the related art. One aspect of the embodiments of the present disclosure is a method of manufacturing a free-standing electrode film for an energy storage device, which may have a high film quality (e.g., with a film score higher than 3.5, 4, or 4.5) making it suitable for a high-speed manufacturing process, that advantageously may use a minimum number of presses. The electrode film that is created may exhibit uniform binder distribution and the active material particles may not be fully covered by the binder insulation layer (e.g., with the average binder coverage less than 50%, less than 30%, or less than 10% of the active particle surface), unlike films produced using slurry coating processes. At the same time, the electrode film may have minimal active particle deformation (e.g., exhibiting an oval shape rather than its original spherical shape after processing, for example) or cracks. Considering both deformed particles and cracked particles to be “damaged” particles, the ratio of damaged particles in the inner active layer (e.g., not the outermost layer of the film) may be less than 10% or less than 5%, for example, unlike free-standing films produced using conventional dry processes. The method may comprise providing a powder mixture including at least one electrode active material and at least one fibrillizable binder, with the powder mixture having been subjected to a shear force to fibrillize the at least one fibrillizable binder. The method may further comprise feeding the powder mixture between a first pair of opposed working rolls having different respective surface speeds to produce a free-standing electrode film. The first pair of opposed working rolls may be controlled so that the different respective surface speeds are at a ratio between 1:1 and 1:10 and a roll gap between the rolls is equal to or larger than 1 μm, for example.

The method may comprise mixing the powder mixture in a high shear mixer, in a batch form or in a continuous form, to subject the powder mixture to the shear force. The method may comprise adding a solvent to the powder mixture during and/or prior to mixing the powder mixture in the high shear mixer. The powder mixture including the solvent may have total solid contents greater than 95% by weight.

In another aspect of the embodiments of the present disclosure, the method may comprise providing a powder mixture including at least one electrode active material, at least one fibrillizable binder, and a solvent, with the powder mixture having total solid contents greater than 95% by weight. The method may further comprise subjecting the powder mixture to a shear force to fibrillize the at least one fibrillizable binder and feeding the powder mixture between a first pair of opposed working rolls having different respective surface speeds to produce a free-standing electrode film. The first pair of opposed working rolls may be controlled so that the different respective surface speeds at a ratio between 1:1 and 1:10 and so that a roll gap between the rolls is equal to or larger than 1 μm, for example.

In another aspect of the embodiments of the present disclosure, the method may comprise providing a powder mixture including at least one electrode active material and at least one fibrillizable binder, with the powder mixture having been subjected to a shear force to fibrillize the at least one fibrillizable binder. The method may further comprise testing the suitability of the powder mixture to produce a free-standing electrode film and, thereafter, feeding the powder mixture between a first pair of opposed working rolls having different respective surface speeds to produce a free-standing electrode film. The first pair of opposed working rolls may be controlled so that the different respective surface speeds at a ratio between 1:1 and 1:10 and so that a roll gap between the rolls is equal to or larger than 1 μm, for example.

The testing of the degree of filbrilization of the powder mixture may include evaluating the film quality of a test film. The test film may be produced by feeding a test batch of the powder mixture between the first pair of opposed working rolls while they are controlled to have the same surface speed or between another pair of opposed working rolls having the same surface speed. Evaluating the film quality may include measuring one or more attributes of the test film selected from the group consisting of a break strength, an elongation percentage prior to breakage, a minimum bending radius, a size of a crack found in a draw direction of the test film, and a size of a crack found in a transverse direction of the test film. Evaluating the film quality may include calculating a film score as a combination of scores associated with measured values of two or more of the attributes. The controlling of the first pair of opposed working rolls may include determining the ratio of the surface speeds and/or the roll gap based at least in part on a result of the testing.

In any of the above aspects, the method may comprise heating the powder mixture to 70° C. or higher before, during or after subjecting the powder mixture to the shear force. The method of heating the powder mixture to 70° C. or higher may be not particularly restricted, and the heating could be performed thermally or even mechanically, in an oven, in a mixer, or on the first pair of opposed working rolls. The method may comprise passing the free-standing electrode film between a second pair of opposed working rolls to reduce the thickness of the free-standing electrode film. The method may comprise controlling the second pair of opposed working rolls to have different respective surface speeds at a ratio between 1:1 and 1:10 and a roll gap equal to or larger than 1 μm. Additional (e.g., third, fourth, fifth, etc.) pairs of rolls may also be used to further reduce the thickness of the free-standing electrode film.

Another aspect of the embodiments of the present disclosure is a free-standing electrode film made according to the methods described herein. The free-standing electrode film may exhibit more uniform binder distribution than films produced using slurry coating processes, with the active material particles not being fully covered by the binder insulation layer, and may have minimal active particle deformation or cracks in comparison to free-standing films produced using conventional dry processes.

Another aspect of the embodiments of the present disclosure is a free-standing electrode film. The free-standing electrode film may comprise one or more electrode active materials. A percentage of damaged active material particles from among the one or more electrode active materials in an inner active layer of the film may be less than 10% of a total number of active material particles in the inner active layer. The free-standing electrode film may further comprise one or more fibrillizable binders including polytetrafluoroethylene (PTFE) that has been elongated by application of a shear force. The one or more fibrillizable binders may cover less than 50% of a combined surface area of the active material particles in the inner active layer.

Another aspect of the embodiments of the present disclosure is a dry electrode manufacturing line capable of producing a free-standing electrode film having a thickness of 80 microns or less (preferably 70 microns or less or 60 microns or less) for a battery cathode, the dry electrode manufacturing line comprising one film formation press and three or fewer film compression presses.

Another aspect of the embodiments of the present disclosure is a dry electrode manufacturing line. The dry electrode manufacturing line may be capable of producing a free-standing electrode film for a battery cathode with a discharge C-rate of up to 0.5-C from a powder mixture containing at least one electrode active material and at least one fibrillizable binder, the dry electrode manufacturing line comprising one film formation press and no more than one film compression press. The dry electrode manufacturing line may be capable of producing a free-standing electrode film for a battery cathode with a discharge C-rate of 0.5 C to 1 C from a powder mixture containing at least one electrode active material and at least one fibrillizable binder, the dry electrode manufacturing line comprising one film formation press and no more than two film compression presses. The dry electrode manufacturing line may be capable of producing a free-standing electrode film for a battery cathode with a discharge C-rate of 1 C to 4 C from a powder mixture containing at least one electrode active material and at least one fibrillizable binder, the dry electrode manufacturing line comprising one film formation press and no more than three film compression press.

The film formation press may comprise a pair of opposed working rolls that are controllable to have different respective surface speeds. The dry electrode manufacturing line may include a film compression press comprising a pair of opposed working rolls that are controllable to have different respective surface speeds. The dry electrode manufacturing line may comprise a high shear mixer configured to subject the powder mixture to a shear force to fibrillize the at least one fibrillizable binder. A percentage of damaged active material particles from among the one or more electrode active materials in an inner active layer of the free-standing electrode film that the dry electrode manufacturing line is capable of producing may be less than 10% of a total number of active material particles in the inner active layer. The one or more fibrillizable binders may cover less than 50% of a combined surface area of the active material particles in an inner active layer of the free-standing electrode film that the dry electrode manufacturing line is capable of producing.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a system for manufacturing an electrode for an energy storage device according to an embodiment of the present disclosure;

FIG. 2 shows an example operational flow of the system;

FIG. 3 is a scanning electron microscope (SEM) image of a free-standing electrode film produced using a speed differential as described herein;

FIG. 4 is an SEM image of a free-standing electrode film produced without a speed differential; and

FIG. 5 is a graph showing a cycle life comparison between different batteries.

### DETAILED DESCRIPTION

The present disclosure encompasses various embodiments of systems for manufacturing electrodes for energy storage devices as well as manufacturing methods and intermediate and final products thereof. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

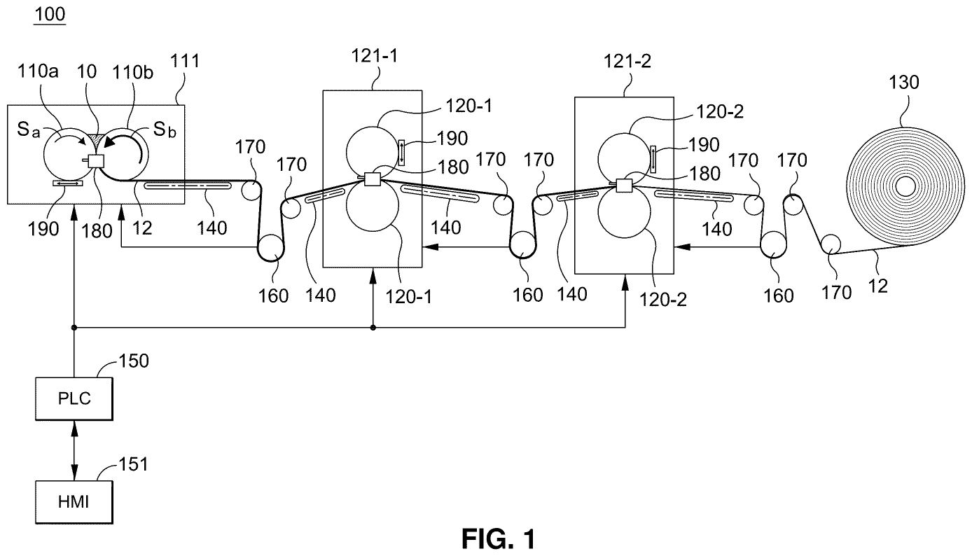

FIG. 1 shows a system 100 for manufacturing an electrode for an energy storage device such as a Li-ion battery, sodium ion battery, solid state battery, Li-ion capacitor (LIC), or ultracapacitor. The finished energy storage device may comprise one or more electrodes made according to the disclosed methods, where each electrode may be assembled by laminating one or more free-standing electrode films 12 produced by the system 100 on a current collector such as an aluminum metal sheet in the case of a cathode electrode or a copper metal sheet in the case of an anode electrode. The system 100 may comprise a pair of opposed working rolls 110a, 110b of a film formation press 111 (also referred to as compaction rolls 110a, 110b), which press a powder mixture 10 into a free-standing film 12. Thereafter, the free-standing film 12 may, if desired, go through one or more additional pairs of thickness reducing working rolls 120-1, 120-2, etc. (collectively referred to as thickness reducing rolls 120) of one or more densification stations 121-1, 121-2, etc. (collectively referred to as densification stations 121, also called film compression presses) before being wound on a spool or film winder 130 or being laminated on a current collector by a laminator. Unlike conventional processes for producing a free-standing electrode film, the disclosed processes described herein utilize the system 100 to control the working rolls 110a, 110b of the film formation press 111, via a programmable logic controller (PLC) or other controller 150, so that they rotate at different speeds Sₐ, S_{b}. As a result of this speed differential, the working rolls 110a, 110b may stretch the free-standing film 12 as it is produced, resulting in a significantly reduced film thickness even before going through any densification stations 121. The number of densification stations 121 may therefore be reduced, advantageously decreasing manufacturing complexity and increasing yield. The total number of pairs of rollers after the film formation press 111 may be three or fewer, in some cases two or fewer, such as one or none, for example. In this way, the entire dry electrode manufacturing line may, for example, have one film formation press and three or fewer film compression presses, while still being capable of producing a free-standing electrode film having a thickness of 80 microns or less (preferably 70 microns or less or 60 microns or less) for a battery cathode.

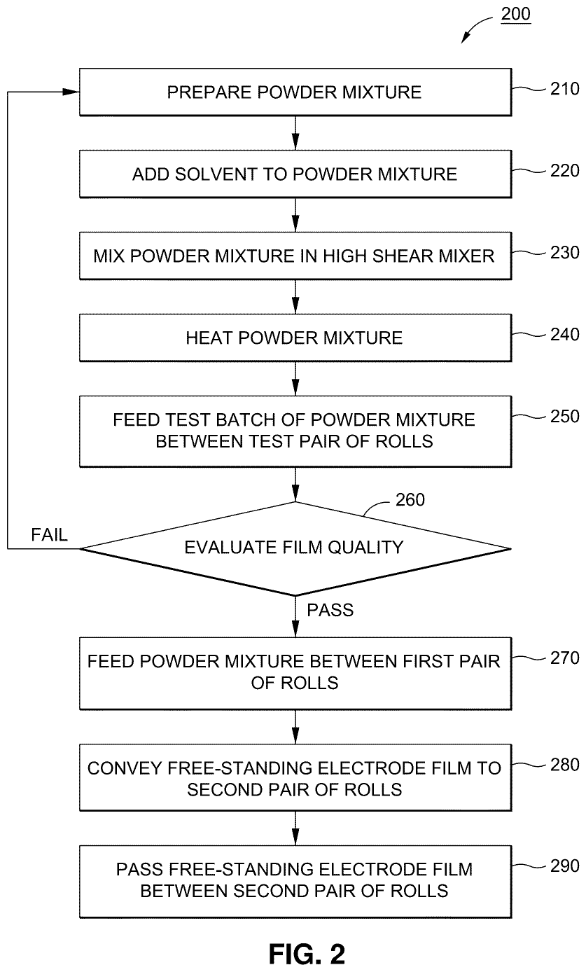

Referring additionally to FIG. 2, an exemplary operational flow 200 for manufacturing an electrode using the system 100 may begin with preparing a powder mixture 10 including at least one electrode active material and at least one fibrillizable binder (step 210). The electrode active material(s) may depend on the particular energy storage devices to be made, such as lithium ion batteries, sodium ion batteries, lithium ion capacitors, or ultracapacitors, and may include, for example, lithium nickel cobalt manganese oxide (NCM), lithium iron phosphate (LFP), lithium manganese phosphate (LMP), lithium nickel phosphate (LNP), or any other lithium metal phosphate (LMP), lithium-sulfur (LS), sulfur carbon composite, lithium nickel cobalt aluminum oxide (NCA), lithium manganese nickel oxide (LMNO), lithium manganese iron phosphate (LMFP), lithium manganese oxide (LMO), lithium cobalt oxide (LCO), or all the above with sodium in place of lithium, graphite, activated carbon, hard carbon, soft carbon, titanium dioxide, and/or silicon or silicon dioxide, or silicon carbide, or any combination of the above. The at least one fibrillizable binder may comprise a thermoplastic binder that is able to stretch and become longer and finer (fibrous) upon application of a shear force, such as polytetrafluoroethylene (PTFE), for example. Additional binders (fibrillizable or otherwise) may be included in the powder mixture 10 as well, and the at least one fibrillizable binder may be a component of a composite binder such as those disclosed in U.S. Patent Application Pub. No. 2022/0158150, entitled “Dry Electrode Manufacture with Composite Binder,” the entire contents of which is incorporated by reference herein. Total binder content in the powder mixture 10 may be less than 8%, preferably less than 4%, and more preferably less than 3% or less than 2%.

The powder mixture 10 may further include a conductive material such as activated carbon, a conductive carbon black such as acetylene black, Ketjen black, or super P (e.g., a carbon black sold under the trade name SUPER P® by Imerys Graphite & Carbon of Switzerland), carbon nanotubes (CNT), carbon nanofiber, graphite particles, graphene, a conducting polymer, and combinations thereof. The conductive material may be an element of a conductive paste comprising a polymer additive mixed with a liquid carrier as described in U.S. Pat. No. 11,508,956 (“the '956 patent”), entitled “Dry Electrode Manufacture with Lubricated Active Material Mixture,” the entire contents of which is incorporated by reference herein. An additive solution as contemplated by the '956 patent, which may comprise a polymer additive mixed with a liquid carrier without necessarily including the conductive material, may also be added to the powder mixture 10 described herein.

In order to chemically activate the at least one fibrillizable binder to improve its adhesion strength (e.g., allowing it to soften further and become more able to stretch without breaking), a highly vaporizable solvent may also be included in the powder mixture 10 as described in U.S. Pat. No. 9,236,599, entitled “Low Cost High Performance Electrode for Energy Storage Devices and Systems and Method of Making Same,” and U.S. Pat. No. 10,069,131, entitled “Electrode for Energy Storage Devices and Method of Making Same,” the entire contents of each of which is incorporated by reference herein. In this regard, the operational flow 200 of FIG. 2 includes a step of adding a solvent to the powder mixture 10 (step 220), but it is noted that the solvent need not necessarily be added to the finished powder mixture 10 and could be added before some or any other components such as the conductive material, for example. The solvent may have a relatively low boiling point of less than 180° C., less than 130° C., or less than 100° C. such that minimal or no drying process is necessary to remove the solvent afterwards (unlike slurry-based and extrusion processes for producing electrodes). Example solvents may include hydrocarbons (e.g., hexane, benzene, toluene), acetates (e.g., methyl acetate, ethyl acetate), alcohols (e.g., propanol, methanol, ethanol, isopropyl alcohol, butanol), glycols, acetone, dimethyl carbonate (DMC), diethyl carbonate (DEC), and tetrachloroethylene. Unlike in the case of slurry-based and extrusion methods, the amount of the solvent may generally be very low, with the powder mixture 10 having total solid contents greater than 95% by weight, for example (with the resultant mixture still being a powder).

In the case of manufacturing an electrode for a solid-state battery, it is contemplated that the powder mixture 10 may include a solid electrolyte powder. The solid electrolyte powder may be a dry electrolyte powder as described in Applicant's co-pending U.S. Patent Application Pub. Nos. 2023/0108113 and 2023/0106377, entitled “Dry Electrode Manufacture for Solid State Energy Storage Devices,” the entire contents of each of which is incorporated by reference herein, and may be primarily (e.g., 80-100% by weight) a ceramic such as a garnet-structure oxide, for example, lithium lanthanum zirconium oxide (LLZO) with various dopants (e.g., Li_{6.5}La₃Zr₂O₁₂ or Li₇La₃Zr₂O₁₂), lithium lanthanum zirconium tantalum oxide (LLZTO) (e.g., Li_{6.4}La₃Z_{1.4}Ta_{0.6}O₁₂), lithium lanthanum zirconium niobium oxide (LLZNbO) (e.g., Li_{6.5}La₃Zr_{1.4}Nb_{0.5}O₁₂), lithium lanthanum zirconium tungsten oxide (LLZWO) (e.g., Li_{6.3}La₃Zr_{1.65}W_{0.35}O₁₂), a perovskite-structure oxide, for example, lithium lanthanum titanate (LLTO) (e.g., Li_{0.5}La_{0.5}TiO₃, Li_{0.34}La_{0.56}TiO₃, or Li_{0.29}La_{0.57}TiO₃) or lithium aluminum titanium phosphate (LATP) (e.g., Li_{1.4}Al_{0.4}Ti_{1.6}(PO₄)₃), a lithium super ionic conductor Li₂₊₂ₓZn₁₋ₓGeO₄ (LISICON), for example, lithium aluminum titanium phosphate (LATP) (e.g., Li_{1.3}Al_{0.3}Ti_{1.7}(PO₄)₃), lithium aluminum germanium phosphate (LAG or sodium super ionic conductor, i.e., NASICON-type LAGP) (e.g., Li_{1.5}Al_{0.5}Ge_{1.5}(PO₄)₃ or Li_{1.5}Al_{0.5}Ge_{1.5}P₃O₁₂), or a phosphate, for example, lithium titanium phosphate (LTPO) (e.g., LiTi₂(PO₄)₃), lithium germanium phosphate (LGPO) (e.g., LiGe₂(PO₄)₃), lithium phosphate (LPO) (e.g., gamma-Li₃PO₄ or Li₇P₃O₁₁), or lithium phosphorus oxynitride (LiPON). As another example, the solid electrolyte powder may be primarily (e.g., 80-100% by weight) a polymer such as PEO, PEO-PTFE, PEO-LiTFSi, PEO-LiTFSi/LLZO, PEO-LiClO₄, PEO-LiClO₄/LLZO, poly(3,4-ethylenedioxythiophene) polystyrene sulfonate (PEDOT:PSS), polyphenylene oxide (PPO), polyethylene glycol (PEG), a polyether-based polymer, a polyester-based polymer, a nitril-based polymer, a polysiloxane-based polymer, polyurethane, poly-(bis((methoxyethoxy)ethoxy)phosphazene) (MEEP), or polyvinyl alcohol (PVA). As another example, the solid electrolyte powder may be primarily (e.g., 80-100% by weight) a sulfide such as lithium sulfide (LS) (e.g., Li₂S), glassy lithium sulfide phosphorus sulfide (LSPS) (e.g., Li₂S—P₂S₅), glassy lithium sulfide boron sulfide (LSBS) (e.g., Li₂S—B₂S₃), glassy lithium sulfide silicon sulfide (LSSiS) (e.g., Li₂S—SiS₂), lithium germanium sulfide (LGS) (e.g., Li₄GeS₄), lithium phosphorus sulfide (LPS) (e.g., Li₃PS₄ such as 75Li₂S-25P₂S₅ or Li₇P₃S₁₁ such as 70Li₂S-30P₂S₅), lithium silicon phosphorus tin sulfide (LSPTS) (e.g., Liₓ(SiSn)P_{y}S_{z}), argyridite Li₆PS₅X (X═Cl, Br) (e.g., LPSBr such as Li₆PS₅Br, LPSCl such as Li₆PS₅Cl, LPSClBr such as Li₆PS₅Cl_{0.5}Br_{0.5}, or LSiPSCl such as Li_{9.54}Si_{1.74}P_{1.44}S_{11.7}Cl_{0.3}), or thio-LISICON (e.g., LGPS such as Li₁₀GePS₁₂). The solid electrolyte powder may also include a halide, a metal-organic framework (MOF), or a borate.

The operational flow 200 of FIG. 2 may continue with subjecting the powder mixture 10 to a shear force (step 230). Whereas preparing the powder mixture 10 in step 210 may broadly contemplate any kind of equipment for combining the ingredients together such as a hand mixer, a V blender, or a cone blender, the mixer for applying the shear force may advantageously be a high shear mixer in a batch form, such as a kitchen blender, an industrial blender, or a multiple roll mill (e.g., a two-roll mill, a three-roll mill, etc.), or in a continuous form, such as a jet mill, a screw mixer, as long as it will apply enough shear force to fibrillize the fibrillizable binder. In this regard, it is contemplated that the preparing of the powder mixture 10 may include mixing the powder mixture 10 (to combine the ingredients) and that the subjecting of the powder mixture 10 to the high shear force may include mixing the powder mixture 10 with a shear force greater than during the preparing of the powder mixture 10. Mixing as part of preparing the powder mixture 10 may cause less fibrillization than the high shear mixing and may preferably cause substantially no fibrillization. It should be noted that the high shear mixer may in some cases be the same appliance that is used to prepare the powder mixture 10, such as where the same mixer is first operated with one setting (e.g., one speed setting) and then operated with another, or the high mixer may in some cases contains multiple zones which provide different shear forces to prepare the powder mixture 10 properly. It is also contemplated that steps 210-230 may overlap to some degree, with the powder mixture 10 being completed after some of the ingredients of the powder mixture 10 have already begun to be subjected to the shear force. For example, the solvent and/or fibrillizable binder may be injected into the high shear mixer or otherwise added (or supplemented) once high shear mixing has already begun. It is contemplated that recycled electrode film material may also be added at this stage or before, for example, as described in Applicant's U.S. Patent Application Pub. No. 2024/0258595, entitled “Free-standing Electrode Film Containing Recycled Materials,” the entire contents of which is incorporated by reference herein.

The process of mixing the powder mixture 10 in the high shear mixer may also have the effect of heating the powder mixture 10 (step 240) due to the thermal energy imparted by the mixer by friction. Instead, or additionally, the heating may be performed prior to the high shear mixing, e.g., in an oven, and/or after the high shear mixing, e.g., either in an oven or on the working rolls 110a, 110b of the film formation press 111 (which may be heated), in which case the heating may occur just prior to and during pressing. Advantageously, raising the temperature of the powder mixture 10 (e.g., to 70° C. or higher) may thermally activate the fibrillizable binder, causing it to become softer and able to stretch longer and finer before breaking, such that the amount of binder needed to reliably produce a free-standing electrode film 12 may be reduced. Examples of thermal activation of the fibrillizable binder may be found in U.S. Pat. No. 11,616,218, entitled “Dry Electrode Manufacture by Temperature Activation Method,” the entire contents of which is incorporated by reference herein.

Once the fibrillizable binder is sufficiently fibrillized, which may help to ensure that the first mixture 10 is able to adequately stretch without excessive breaking, the operational flow 200 of FIG. 2 may continue with optional steps of evaluating a test batch (steps 250 and 260, described below in more detail), followed by feeding the powder mixture 10 between the working rolls 110a, 110b of the film formation press 111 to produce a free-standing electrode film 12 (step 270). The film formation press 111 may be a roller press and may typically include working rolls 110a, 110b arranged horizontally so that the film 12 may emerge from the bottom thereof as it is produced from a powder mixture 10 that is poured on top. Advantageously, because the powder mixture 10 has been subjected to a shear force to fibrillize the at least one fibrillizable binder, the working rolls 110a, 110b are able to produce a free-standing electrode film 12, i.e., a self-supporting electrode active layer that maintains structural integrity without the need for a traditional metallic current collector (such as copper or aluminum) or any other substrate or supportive surface (e.g., the working rolls themselves) during or after its formation. The quality of the free-standing electrode film 12 may be further improved by chemical and/or thermal activation as described above. Having emerged from the working rolls 110a, 110b of the film formation press 111, the free-standing electrode film 12 may optionally pass through one or more pairs of thickness reducing working rolls 120, 120 of one or more densification stations 121 as described in more detail below before being wound on a spool or film winder 130.

As noted above, it has been found that the use of different speeds Sₐ, S_{b} of the working rolls 110a, 110b may result in a significantly reduced initial film thickness and, thus, a reduction in the number of thickness-reducing rolls 120 that are needed to produce a given final thickness of the electrode film 12. To this end, each working roll 110a, 110b of the film formation press 111 may be independently driven by a high accuracy gear-reducer and a servo motor. Each servo motor may be controlled by a servo drive that receives motion parameters from the PLC or other controller 150, which may share tags with and be controlled via a human machine interface (HMI) 151, for example. The servo motors of the film formation press 111 may receive a direct tension measurement as a feedback signal from a load cell idler 160, which may be provided between a pair of idlers 170 downstream of the film formation press 111, for example. Based on the tension measurement, the servo motors may maintain a line speed set-point and modulate the roll speeds Sₐ, S_{b} to maintain a tension set-point, while further independently controlling the roll speeds Sₐ, S_{b} to establish a desired speed differential or delta, all as a closed loop. The set-point parameters and speed differential may be provided to the servo motors of the film formation press 111 by the PLC 150, which may receive input and provide feedback to an operator via the HMI 151, for example.

The roll gap between the working rolls 110a, 110b of the film formation press 111 may similarly be controlled by an operator via the HMI 151. To this end, the film formation press 111 may be fitted with a set of precision gap setting devices, e.g., a pair of gap adjusters 180, that provide the ability to set and maintain a uniform gap opening between the two working rolls 120a, 120b. Each adjuster 180 may have an input shaft that, when turned, increases or decreases the gap width between the rolls, with the gap being adjustable at a micron level precision, for example. One of the working rolls 110a may be fixed in place and the other may be attached to a set of linear bearings or roll guides 190, for example, which may allow the compaction roll assembly to move in and out when making adjustments to the gap. The shaft can either be turned manually or be connected to a servo motor and then adjusted through the HMI 151 and PLC 150. The gap adjusters 180 may be manually calibrated to a physical baseline gap value or there may be direct feedback from a measuring device such as a linear variable differential transformer (LVDT) or laser sensor.

The beneficial use of different speeds Sₐ, S_{b} of the working rolls 110a, 110b is understood to depend, at least in part, on the unique structural characteristics of a powder mixture 10 containing a fibrillizable binder that has been subjected to a shear force. The powder mixture 10 itself contains elongated fibers of the binder and may have a consistency of a loose form of powder that becomes sticky when squeezed. When such a powder mixture 10 is pressed by the film formation press 111, the resulting film 12 may be considered free-standing or self-supporting because it has significantly greater structural integrity than a typical film pressed from a powder mixture. Such typical films must remain in a mold, on a substrate, on a carrier, or on the rollers themselves in order to remain intact, in contrast to the free-standing film 12 described herein which may freely pass from one to the next element of the system 100 in a self-supporting state.

The working rolls 110a, 110b may preferably be controlled to define a surface speed ratio Sₐ:S_{b} of between 1:1 and 1:10 and a roll gap of equal to or larger than 1 μm, with the optimal surface speed ratio and roll gap depending both on the desired thickness reduction and on the degree of filbrilization of the powder mixture 10. In the case of producing an electrode film 12 having NCM811 as an electrode active material, for example, a high-quality film 12 having a thickness of under 200 μm may be produced according to the disclosed methods using only the film formation press 111 (i.e., without any densification stations 121), with the working rolls 110a, 110b being controlled to define a surface speed ratio of between 1:2 (e.g., Sₐ=3 m/min and S_{b}=6 m/min) and 1:3 (e.g., Sₐ=3 m/min and S_{b}=9 m/min) and at a roll gap of 10 μm. In this case, a battery C rate of 0.5 C may be easily made using the high-quality film 12 itself (coming directly from the film formation press 111), or by adding one compression station 121 to compress the film 12 with an appropriately optimized roll gap and speed ratio selection as described above. It is found that adding one or two compression stations 121 to compress the film 12 with an optimized roll gap and speed ratio selection, a free-standing film to meet the battery C rate of 1 C may be easily made. At a lower surface speed ratio such as 1:1.5 or 1:1, it is found that the quality of the film deteriorates, and in some cases compression lines and cracking in the draw direction are found to occur. Higher surface speed ratios such as 1:4 or 1:5 increase the amount of stretching and result in an electrode film 12 that is thinner than 100 μm but unnecessarily fragile. (To produce thinner films, such as 65 μm or less for an electric vehicle battery to meet the battery C rate of 3 C or 4 C, it may be preferable to pass the high-quality film 12 that was produced by the film formation press 111 through two or more densification stations 121 to further reduce its thickness as described in more detail below.) By increasing the roll gap from 10 μm to 20 μm, a high-quality film may be produced having a somewhat greater thickness of between 200 μm and 230 μm at 1:2, 1:3, or 1:4 surface speed ratios. Roll gaps larger than 20 μm are found to decrease the quality of the film, with no film being formed at all when the roll gap is above 500 μm.

As another example, the optimal parameters for producing an electrode film 12 having LFP as an electrode active material differ somewhat, with film quality becoming acceptable at a 250 μm roll gap or greater. Narrower roll gaps result in formation of holes in the microstructure of the electrode film 12 and breakage of the film 12 as the particles become cracked or otherwise damaged. At a 250 μm roll gap, a high-quality film 12 may be produced using a 1:3 surface speed ratio of the working rolls 110a, 110b, but the film quality deteriorates at ratios of 1:2 or lower and at ratios of 1:4 or greater. The thickness of the film 12 produced by the film formation press 111 in this way is found to be between 300 μm and 350 μm. Again in this case, adding one compression station 121 to compress the film 12 with an appropriately optimized roll gap and speed ratio selection as described above, a free-standing film to meet the battery C rate of 0.5 C may be easily made. It is found that by adding two compression stations 121 to compress the 12 with an optimized roll gap and speed ratio selection, a free-standing film to meet the battery C rate of 1 C is easily made. By increasing the roll gap to 500 μm, the range of surface speed ratios that produce a reasonably high-quality film 12 becomes greater, with anywhere from 1:2 to 1:5 yielding acceptable films 12 that are 600-700 μm thick. At greater roll gaps, such as 750 μm and above, the film 12 is too thick and not usable and is also of poorer quality, being weaker and more prone to breakage.

As noted above, the specific surface speed ratio Sₐ:S_{b} and roll gap to be used may be determined at least in part based on the degree of filbrilization of the powder mixture 10. For example, the degree of fibrillization that has occurred may affect the strength of the film 12 and how much it can be stretched by the rolls 110a, 110b without tearing. The specific surface speed ratio Sₐ:S_{b} and roll gap to be used may also depend on the active materials (hard or soft materials, particle size and particle size distribution, single or polycrystal, etc.) and/or the use of any processing additives as discussed above (solvent, conductive material, additive solution, etc.). In order to evaluate the powder mixture 10 for purposes of selecting a surface speed ratio Sₐ:S_{b} and/or roll gap (or in some cases scrapping a batch of powder mixture 10 if necessary), the operational flow 200 may include feeding a test batch of the powder mixture 10 between a test pair of rolls that have the same surface speed as each other, i.e., without a speed differential (step 250). As a practical matter, the test pair of rolls may be the same first pair of opposed working rolls 110a, 110b while they are controlled to have the same surface speed or may be another pair of opposed working rolls having the same surface speed (so that the settings of the film formation press 111 don't need to be changed to conduct the testing). The film quality of the resulting test film may be evaluated by a variety of methods and may include, for example, measuring one or more attributes of the test film such as a break strength when the test film is stretched in a draw direction, an elongation percentage prior to breakage, a flexibility measurement such as a minimum bending radius around a film winder prior to breakage, a size of any crack found to occur in a draw direction of the test film, and/or a size of any crack found to occur in a transverse direction of the test film. A quantitative film score may be calculated as a combination of scores associated with the measured values of two or more such attributes. Qualitative evaluation of the film quality (including qualitative scoring in multiple categories) may also be taken into consideration, for example, as a way of eliminating very low-quality films from consideration before conducting more time-intensive quantitative testing.

As one specific example, a qualitative film score may be calculated as an average score based on qualitative scoring criteria as shown in Table 1, below:

TABLE 1

| Score | 0 | 1 | 2 | 3 | 4 | 5 |
|---|---|---|---|---|---|---|
| Side | Tiny | Side | Side cracks | During 1st | During 1st | Only very |
| Crack | pieces. | cracks | after 1st | press, side | press, side | small side |
| | Not a | after 1st | press are | cracks are | cracks are | cracks |
| | complete | press are | large. Side | medium/small. | small. | during 1st |
| | sheet | large. | cracks | Some | Some | press. No |
| | | Final side | deepen and | continued | continued | side cracks |
| | | cracks are | continue to | cracking | cracking | appear |
| | | long and | grow with | during | during | during |
| | | deep, | additional | additional | additional | additional |
| | | causing | presses. | presses, but | presses, | presses. |
| | | significant | Final side | overall cracks | but overall | |
| | | reduction | cracks still | remain | cracks | |
| | | of usable | cause | medium/small. | remain | |
| | | film | significant | | small. | |
| | | width. | reduction of | | | |
| | | | usable film | | | |
| | | | width. | | | |
| Vertical | Tiny | Large | Some | Some | Some | Only very |
| Crack | pieces. | vertical | vertical | medium/small | small | small |
| | Not a | cracking | cracking | vertical | vertical | vertical |
| | complete | during 1st | during 1st | cracking | cracking | cracks |
| | sheet. | press. | press. | during 1st | during 1st | during 1st |
| | | Film | Cracking | press. Only | press. | press. No |
| | | doesn't | increases | minimal | Only | cracks |
| | | survive | with | vertical | minimal | appear |
| | | being | multiple | cracking in | vertical | during |
| | | pressed | presses. | center of film. | cracking | additional |
| | | multiple | Film doesn't | | in center | presses. |
| | | times. | survive | | of film. | |
| | | | being | | | |
| | | | pressed | | | |
| | | | more than 2- | | | |
| | | | 3 times. | | | |
| Flexibility | Super | Difficult | Breaks | Won't break | Able to be | Easy to |
| | brittle. | to handle | when gently | when loosely | loosely | handle. |
| | Falls | but can | bent/folded | folded over or | folded and | Can be |
| | apart | still be | over. Can be | bent. Breaks | rolled. | folded, |
| | when | moved if | handled | when loosely | Survives | rolled, or |
| | easily. | care is | carefully. | rolled. Not too | being | bent |
| | Very | taken. | | difficult to | bent. Easy | tightly |
| | difficult | | | handle. | to handle. | without |
| | to | | | | | much |
| | handle. | | | | | difficulty |
| | | | | | | or |
| | | | | | | breaking. |
| Strength | Falls | Film | Easier to | Film can | Film can | Film can |
| | apart | cannot | handle but | support its own | support its | support its |
| | easily. | support its | film still | weight. Good | own | own |
| | Very | own | cannot | amount of | weight. | weight. |
| | difficult | weight. | support its | strength in film | Good | Almost an |
| | to | Difficult | own weight. | draw direction, | amount of | equal |
| | handle. | to handle. | Weak in all | but some | strength in | amount of |
| | | Weak in | directions. | weakness in | film draw | strength in |
| | | all | | counter | direction | draw |
| | | directions. | | direction. | and in | direction |
| | | | | | counter | and in |
| | | | | | direction. | counter |
| | | | | | | direction. |
| Holes | A lot of | A lot of | Some larger | A few | A few | No holes. |
| | holes. | holes but | holes and | medium/small | small | |
| | Not 1 | still 1 | few | holes. | holes. | |
| | sheet. | sheet. | medium/ | | | |
| | Just | | small holes. | | | |
| | pieces. | | | | | |

Using the criteria in Table 1, a judgement may be made as to the film's score (0, 1, 2, 3, 4, or 5) in each category (side crack, vertical crack, flexibility, strength, and holes). The scores in each category may then be averaged to calculate the qualitative film score. A qualitative film score greater than some threshold (e.g., 3.5) may be considered a Pass, whereas a qualitative film score less than or equal to the same threshold may be considered a Fail. For manufacture scalability, the higher the score is, the higher the speed at which an electrode line could be running without excess film break incidents during production.

In a case where the qualitative film score is a Pass, a quantitative film score may then be calculated as a finer, more rigorous evaluation of the film. Example quantitative film score criteria for a cathode film in NMC series is shown in Table 2, below:

TABLE 2

| Score | 0 | 1 | 2 | 3 | 4 | 5 |
|---|---|---|---|---|---|---|
| Peak Break | <100/ | 100-199 | 200-299 | 300-399 | 400-500 | >500 |
| Force (kPa) | Can't load | | | | | |
| [Strength #1] | film for | | | | | |
| | testing | | | | | |
| Elongation | <0.5/ | 0.50-0.99 | 1.00-1.49 | 1.50-1.99 | 2.00-3.00 | >3.00 |
| (%) | Can't load | | | | | |
| [Strength #2] | film for | | | | | |
| | testing | | | | | |
| Bending | >75/ | 75 | 50 | 40 | 30 | 20 |
| Diameter | Can't rest | | | | | |
| (mm) | on largest | | | | | |
| [Flexibility] | diameter | | | | | |
| | without | | | | | |
| | cracking | | | | | |
| Side Crack | >40 | 40-36 | 35-26 | 25-16 | 15-10 | <10 |
| Size (mm) | | | | | | |
| [Side | | | | | | |
| Cracking] | | | | | | |
| Vertical | >60 | 60-56 | 55-50 | 49-30 | 29-15 | <15 |
| Crack Size | | | | | | |
| (mm) | | | | | | |
| [Vertical | | | | | | |
| Cracking] | | | | | | |

Example quantitative film score criteria for a graphite anode film is shown in Table 3, below:

TABLE 3

| Score | 0 | 1 | 2 | 3 | 4 | 5 |
|---|---|---|---|---|---|---|
| Peak Break | <50/ | 50-149 | 150-199 | 200-249 | 250-300 | >300 |
| Force (kPa) | Can't load | | | | | |
| [Strength #1] | film for | | | | | |
| | testing | | | | | |
| Elongation | <0.2/ | 0.20-0.59 | 0.60-0.79 | 0.80-0.99 | 1.00-1.20 | >1.20 |
| (%) | Can't load | | | | | |
| [Strength #2] | film for | | | | | |
| | testing | | | | | |
| Bending | >75/ | 75 | 50 | 40 | 30 | 20 |
| Diameter | Can't rest | | | | | |
| (mm) | on largest | | | | | |
| [Flexibility] | diameter | | | | | |
| | without | | | | | |
| | cracking | | | | | |
| Side Crack | >40 | 40-36 | 35-26 | 25-16 | 15-10 | <10 |
| Size (mm) | | | | | | |
| [Side | | | | | | |
| Cracking] | | | | | | |
| Vertical | >60 | 60-56 | 55-50 | 49-30 | 29-15 | <15 |
| Crack Size | | | | | | |
| (mm) | | | | | | |
| [Vertical | | | | | | |
| Cracking] | | | | | | |

More specifically, for a given film thickness to be tested, two full-width pieces of the film may be prepared, each 15 cm in length. One piece may be used to cut out 10 cm (L)×2.5 cm (W) test samples and 15 cm (L)×5 cm (W) test samples, with the lengths (L) being measured in the film draw direction (i.e., machine direction) of the original piece and the widths (W) being measured in the transverse direction. The other full-width piece of film may be used to cut a larger 10 cm (L)×2.5 cm (W) test sample. Additional pieces of the film may be used as needed. Referring to Tables 2 and 3, the peak break force in kPa (strength test #1) and elongation % (strength test #2) may be measured by pulling a 10 cm (L)×2.5 cm (W) test sample in the film draw direction until it breaks. The normalized tensile strength (kPA) may be equal to −0.00980665 (N/gf)×maximum recorded force (gf)/cross-sectional area (m²). The elongation (%) may be equal to [recorded start value (mm)−value at break (mm)]/total length of sample (e.g., 100 mm)×100%. The bending diameter (flexibility) may be measured by wrapping a 15 cm (L)×5 cm (W) test sample around successively smaller diameter cylinders (e.g., metal rods), such as diameters of 75 mm, 50 mm, 40 mm, 30 mm, 20 mm, with the film being passed from one to the next cylinder as long as it does not begin to crack. It may also be verified at this stage whether the film can be wound on a spool (e.g., wound tightly around multiple times without cracking), as different systems other than roll-to-roll handling may be needed if the film cannot be wound, even if the flexibility of the film is otherwise suitable for a scalable process. The side and vertical cracking size of the film may be measured by examining the film for any cracks and measuring their length with a ruler and/or calipers, for example. While peak break force and % elongation may be the most important indicators of scalability, flexibility and cracking scores help determine the formulation's ability to be handled throughout the film-making process as well as the final usable film width that will be laminated into electrodes. It is noted that the same qualitative and quantitative evaluations may be undertaken at multiple different thicknesses of the film.

Using the criteria in Table 2 or 3 (depending on whether the electrode film is a cathode film or an anode film), the electrode film may be scored (0, 1, 2, 3, 4, or 5) in each category (peak break force, elongation, bending diameter, side crack size, and vertical crack size). The scores in each category may then be averaged to calculate the quantitative film score. A quantitative film score greater than some threshold (e.g., 3.5) may be considered a Pass, whereas a quantitative film score less than or equal to the same threshold may be considered a Fail. If both the qualitative film score and the quantitative film score result in a Pass, the mixture recipe and other process parameters (e.g., high shear mixing time) may be considered suitable for use. For manufacture scalability, the higher the score is, the higher the speed at which an electrode line could be running without excess film break incidents during production. In addition to evaluating the film quality as described above, the film samples may also be used to collect film properties such as thickness, weight, 4-probe sheet resistance, density, porosity, conductivity, and loading (e.g., using a 1-inch punch, or similar).

Depending on the outcome of the evaluation, adjustments may be made to the speed differential and/or roll gap. For example, a smaller difference between the surface speeds Sₐ, S_{b} may be used in a case where the degree of the fibrillization of the powder mixture 10 is determined to be close to the film score threshold, or else the resulting film 12 may not be able to withstand as high a degree of stretching imparted by the speed differential. For a powder mixture 10 with a higher degree of fibrillization and thus a higher film score, a higher difference between the surface speeds Sₐ, S_{b} may be used. In this case, the resulting free-standing film will be thinner, and thus the number of presses needed may be further reduced. As shown in FIG. 2, in the case of a FAIL result at step 260, the process may in some cases start over with preparing a new powder mixture (step 210) based on the results of the evaluation.

In order to further reduce the thickness of the free-standing film 12 as may be desired for the particular application, the operational flow 200 may continue with conveying the film 12 to one or more thickness reducing rolls 120 of one or more densification stations 121 as described above (step 280). The thickness reducing rolls 120 of the densification station(s) 121, if included, may typically be arranged vertically as depicted in FIG. 1. Like the working rolls 110a, 110b of the film formation press 111, each working roll 120 of each densification station 121 may be independently driven by a high accuracy gear-reducer and servo motor, with each servo motor controlled by a servo drive that receives parameters from the controller 150 (which may be set via the HMI 151, for example). The servo motors of each densification station 121 may receive a direct tension measurement as a feedback signal from a corresponding load cell idler 160, which may be provided between a pair of idlers 170 downstream of the respective densification station 121 as shown in FIG. 1. Based on the tension measurements, the servo motors of each densification station 121 may control the rolls 120 in the same way as the servo motors of the film formation press 111 control the rolls 110a, 110b, with relevant set-point parameters and speed differential (if any) being provided to the servo motors of each densification station 121 by the PLC 150 and HMI 151. Each densification station 121 may likewise have corresponding gap adjusters 180, roll guides 190, etc. for adjusting the roll gap between the rolls 120, which may likewise be controlled via the PLC 150 and HMI 151 (or manually controlled) as described above.

With the speeds of the thickness-reducing rolls 120 and the roll gap set, the operational flow 200 may continue with passing the free-standing film 12 through each pair of thickness-reducing rolls 120 to further reduce the thickness of the film 12 (step 290) before the film 12 is wound on the film winder 130. The thickness-reducing rolls 120 of the densification station(s) 121 may operate with a speed differential (e.g., respective surface speeds at a ratio between 1:1 and 1:10) in order to further stretch the film 12 to more substantially reduce its thickness. Alternatively, the thickness-reducing rolls 120 may operate without a speed differential. As in the case of the rolls 110a, 110b of the film formation press 111, the roll gap between the rolls 120 of each densification station 121 may preferably be equal to or larger than 1 μm. The decision of what, if any, speed differential to use, as well as how large of a roll gap, may be made based on the desired characteristics of the finished film 12 as well as the material and degree of filbrilization of the powder mixture 10 used to produce it. This may be determined at least in part based on the evaluation of film quality described above.

Owing to the novel use of a speed differential to stretch the free-standing electrode film 12 as it is produced from the powder mixture 10 as described herein, it is found that target film thickness can be achieved with fewer presses than are used in conventional methods. Achieving an active layer film thickness of 65 μm or less for an electric vehicle battery, for example, may be accomplished using only the film formation press 111 plus one or two densification stations 121 (or in some cases none), in contrast to five or more presses that might otherwise be necessary when using conventional methods. As a result, the subject matter described herein may advantageously increase the scalability of dry electrode manufacturing methods, requiring fewer roller presses and thus lowering equipment and operational costs.

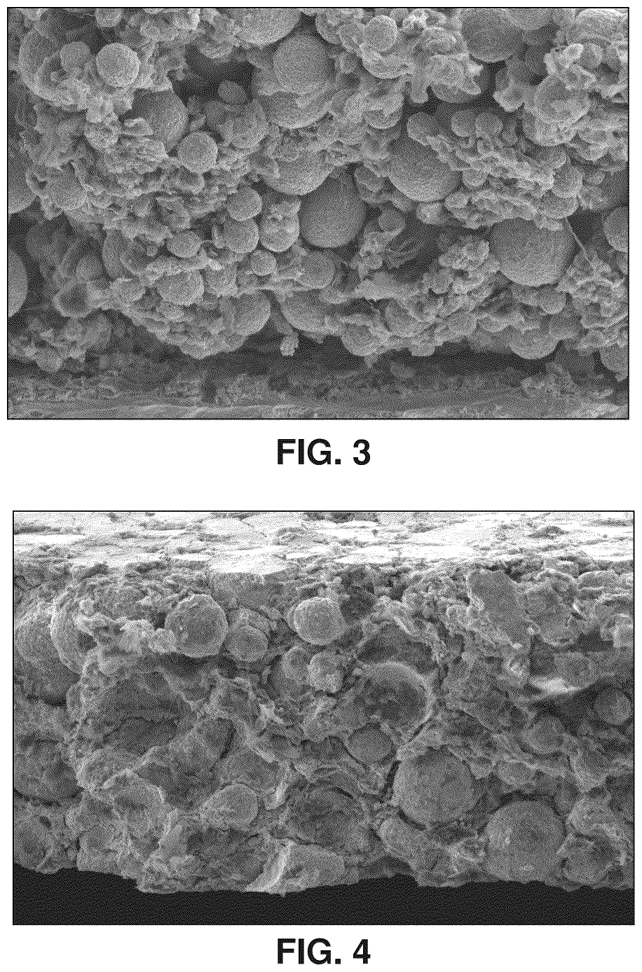

The free-standing electrode film 12 produced using a speed differential as described herein may differ structurally from electrode films made by other processes, as shown in the scanning electron microscope (SEM) images of FIGS. 3 and 4. FIG. 3 is an SEM image (at 3500 times magnification) of an NMC811 material free-standing electrode film 12 produced using a speed differential as described herein, and FIG. 4 is an SEM image (at 3500 times magnification) of the same NMC material free-standing electrode film produced with a 1:1 surface speed ratio. As can be seen, the active material particles that are visible in FIG. 3 (the spherical objects of varying size) are intact, without many damaged particles visible in the image. This is due to the reduced compression force applied to the powder mixture as the differential speed instead stretches the powder mixture into a film. In contrast, there is significant damage to the active material particles shown in FIG. 4, owing to the compression force of the film formation press having the 1:1 surface speed ratio. Through the use of the systems and methods described herein, the present disclosure contemplates a free-standing electrode film 12 comprising one or more electrode active materials and one or more fibrillizable binders including polytetrafluoroethylene (PTFE) that has been elongated by application of a shear force, with the percentage of damaged active material particles in an inner active layer (e.g., not the outermost layer of the film) being less than 10% of the total number of active material particles in the inner active layer (e.g., not the outermost layer of the film), preferably less than 5%. At the same time, unlike in electrode films made by slurry coating processes (which may likewise exhibit few, if any, damaged particles), the active material particles in the contemplated free-standing electrode film 12 may have exposed surfaces that are at least partially unblocked by the binder due to the dry manufacturing process, in contrast to the complete coating of the active material particles that occurs while the mixture is in a liquid state during slurry coating. For example, the surfaces of the active material particles of the contemplated free-standing electrode film 12 may be covered less than 50% by the binder (e.g., the binder may cover less than 50% of a combined surface area of the active material particles), preferably less than 30% and more preferably less than 20%. More generally, the surfaces of the active material particles may differ noticeably from the case of the slurry coating process (and result in substantially improved conductivity) as long as binder coverage is less than 80%, though the exact degree of coverage may depend on the amount of PTFE in the formulation and the degree of fibrillization.

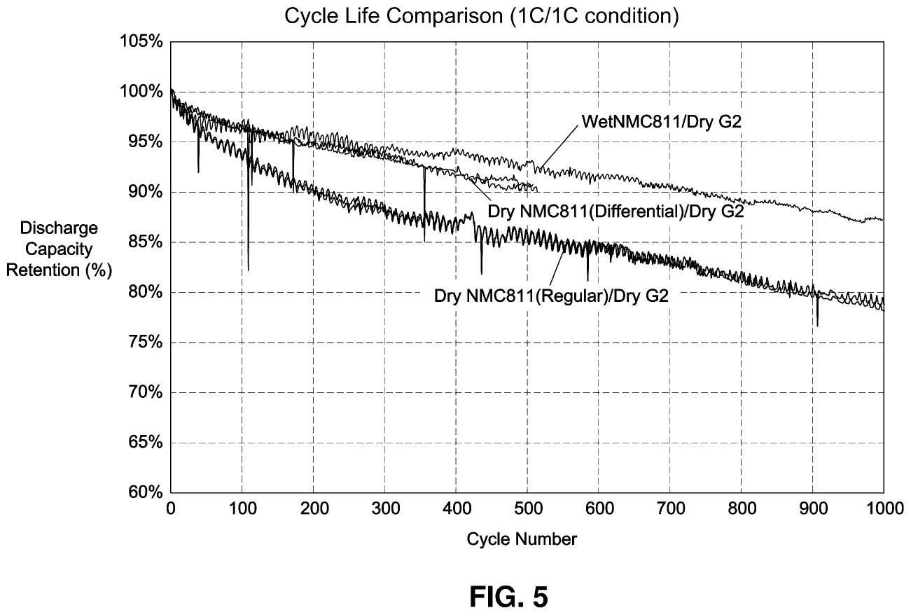

FIG. 5 is a graph showing a cycle life comparison (1 C/1 C condition) between different batteries, with cycle number on the x-axis and discharge capacity retention (%) on the y-axis. Data of three NMC811 batteries is shown, one having electrodes produced by a wet, slurry coating process, one having electrodes produced by a dry process without a speed differential (i.e., with a 1:1 surface speed ratio of the film formation press), and one having electrodes prepared by a dry process incorporating a speed differential as described herein. As can be seen, discharge capacity retention remains above 90% after 300 cycles, after 400 cycles, and even after 500 cycles for the dry process incorporating the speed differential, while at the same time the disadvantages associated with slurry coating processes can be avoided. In contrast, in the case of the dry process without the speed differential, the discharge capacity retention falls below 90% after just 200 cycles.

In order to allow for convenient insertion of one or more densification stations 121 after the film formation press 111, it is contemplated that the system 100 may incorporate the use of one or more mill line expansion modules containing the densification station(s) 121. Examples of mill line expansion modules are described in Applicant's U.S. Patent Application Pub. No. 2023/0411585, entitled “Free-standing Electrode Film for Dry electrode Manufacture,” and Applicant's U.S. Patent Application Pub. No. 2023/0411588, entitled “Free-standing Electrode Film Manufacture Using High Precision Press,” the entire contents of each of which is incorporated by reference herein. In some cases, the finished free-standing electrode film 12 may be directly laminated onto a current collector as also described in these documents, in which case the film winder 130 may be omitted.

As noted above, the disclosed speed differential between the working rolls 110a, 110b may advantageously stretch the free-standing film 12 as it is produced, resulting in a significantly reduced film thickness even before going through any densification stations 121. The number of densification stations 121 (as well as the number of film formation presses 111) may therefore be reduced, advantageously decreasing manufacturing complexity and increasing yield. As a result, the disclosed dry electrode manufacturing line (system 100) may be capable of producing a free-standing electrode film for a battery cathode with a discharge C-rate of up to 0.5 C using one film formation press 111 and no more than one film compression press 121. The dry electrode manufacturing line (system 100) may further be capable of producing a free-standing electrode film for a battery cathode with a discharge C-rate of 0.5 C to 1 C using one film formation press 111 and no more than two film compression presses 121. The dry electrode manufacturing line (system 100) may further be capable of producing a free-standing electrode film for a battery cathode with a discharge C-rate of 1 C to 4 C using one film formation press 111 and no more than three film compression presses 121.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A dry electrode manufacturing line capable of producing a free-standing electrode film for a battery cathode with a discharge C-rate of up to 0.5 C from a powder mixture containing at least one electrode active material and at least one fibrillizable binder, the dry electrode manufacturing line comprising one film formation press and no more than one film compression press.

2. The dry electrode manufacturing line of claim 1, wherein the film formation press comprises a pair of opposed working rolls that are controllable to have different respective surface speeds.

3. The dry electrode manufacturing line of claim 1, wherein the dry electrode manufacturing line includes a film compression press comprising a pair of opposed working rolls that are controllable to have different respective surface speeds.

4. The dry electrode manufacturing line of claim 1, further comprising a high shear mixer configured to subject the powder mixture to a shear force to fibrillize the at least one fibrillizable binder.

5. The dry electrode manufacturing line of claim 1, wherein a percentage of damaged active material particles from among the one or more electrode active materials in an inner active layer of the free-standing electrode film that the dry electrode manufacturing line is capable of producing is less than 10% of a total number of active material particles in the inner active layer.

6. The dry electrode manufacturing line of claim 1, wherein the one or more fibrillizable binders covers less than 50% of a combined surface area of the active material particles in an inner active layer of the free-standing electrode film that the dry electrode manufacturing line is capable of producing.

7. A dry electrode manufacturing line capable of producing a free-standing electrode film for a battery cathode with a discharge C-rate of 0.5 C to 1 C from a powder mixture containing at least one electrode active material and at least one fibrillizable binder, the dry electrode manufacturing line comprising one film formation press and no more than two film compression presses.

8. The dry electrode manufacturing line of claim 7, wherein the film formation press comprises a pair of opposed working rolls that are controllable to have different respective surface speeds.

9. The dry electrode manufacturing line of claim 7, wherein the dry electrode manufacturing line includes a film compression press comprising a pair of opposed working rolls that are controllable to have different respective surface speeds.

10. The dry electrode manufacturing line of claim 7, further comprising a high shear mixer configured to subject the powder mixture to a shear force to fibrillize the at least one fibrillizable binder.

11. The dry electrode manufacturing line of claim 7, wherein a percentage of damaged active material particles from among the one or more electrode active materials in an inner active layer of the free-standing electrode film that the dry electrode manufacturing line is capable of producing is less than 10% of a total number of active material particles in the inner active layer.

12. The dry electrode manufacturing line of claim 7, wherein the one or more fibrillizable binders covers less than 50% of a combined surface area of the active material particles in an inner active layer of the free-standing electrode film that the dry electrode manufacturing line is capable of producing.

13. A dry electrode manufacturing line capable of producing a free-standing electrode film for a battery cathode with a discharge C-rate of 1 C to 4 C from a powder mixture containing at least one electrode active material and at least one fibrillizable binder, the dry electrode manufacturing line comprising one film formation press and no more than three film compression presses.

14. The dry electrode manufacturing line of claim 13, wherein the film formation press comprises a pair of opposed working rolls that are controllable to have different respective surface speeds.

15. The dry electrode manufacturing line of claim 13, wherein the dry electrode manufacturing line includes a film compression press comprising a pair of opposed working rolls that are controllable to have different respective surface speeds.

16. The dry electrode manufacturing line of claim 13, further comprising a high shear mixer configured to subject the powder mixture to a shear force to fibrillize the at least one fibrillizable binder.

17. The dry electrode manufacturing line of claim 13, wherein a percentage of damaged active material particles from among the one or more electrode active materials in an inner active layer of the free-standing electrode film that the dry electrode manufacturing line is capable of producing is less than 10% of a total number of active material particles in the inner active layer.

18. The dry electrode manufacturing line of claim 13, wherein the one or more fibrillizable binders covers less than 50% of a combined surface area of the active material particles in an inner active layer of the free-standing electrode film that the dry electrode manufacturing line is capable of producing.
